(19) United States
(12) Patent Application Publication
(10) Pub. No.: US 2011/0246658 A1
(43) Pub. Date: Oct. 6, 2011

(54) DATA EXCHANGE OPTIMIZATION IN A PEER-TO-PEER NETWORK

(75) Inventors: Paolo Dettori, Hartsdale, NY (US); Julio Nogima, Tarrytown, NY (US); Frank A. Schaffa, Hartsdale, NY (US); Peter Westerink, Ossining, NY (US); Chai W. Wu, Poughquag, NY (US)

(73) Assignee: INTERNATIONAL BUSINESS MACHINES COPORATION, Armonk, NY (US)

(21) Appl. No.: 12/753,954

(22) Filed: Apr. 5, 2010

(51) Int. Cl. G06F 15/16

(52) U.S. Cl. 709/231; 709/233

(57) ABSTRACT

The invention provides a method, system, and program product for optimizing data exchange in a peer-to-peer network (PTPN). In one embodiment, the invention provides a method of optimizing real-time data exchange in a peer-to-peer network (PTPN), the method comprising: receiving, from each peer in the PTPN: an upload limit of the peer; a download limit of the peer; and a delay to each other peer in the PTPN; determining, for each peer in the PTPN: a rate at which data may be transferred to at least one other peer in the PTPN (transfer rate); and a rate at which data may be received from at least one other peer in the PTPN (receive rate); and instructing each peer in the PTPN to: transfer data to at least one other peer in the PTPN at the transfer rate; and receive data from at least one other peer in the PTPN at the receive rate.

### BACKGROUND OF THE INVENTION

The present invention relates generally to data exchange and, more particularly, to the optimization of data exchange between or among two or more peers in a peer-to-peer network.

Peer-to-peer networks (PTPNs) have been used to improve data exchange between peers, often referred to as nodes, by exchanging data directly between peers rather than through an intermediary server. PTPNs can provide improved efficiencies, particularly where large amounts of data are exchanged, such as in video conferencing. The capabilities and limitations of individual peers can vary greatly, however, and managing an individual peer's data exchange based only on that peer's capabilities and limitations will limit the extent of the efficiencies a PTPN can provide.

### BRIEF SUMMARY

The invention provides a method, system, and program product for optimizing data exchange in a peer-to-peer network.

A first aspect of the invention provides a method of optimizing real-time data exchange in a peer-to-peer network (PTPN), the method comprising: receiving, from each peer in the PTPN: an upload limit of the peer; a download limit of the peer; and a delay to each other peer in the PTPN; determining, for each peer in the PTPN: a rate at which data may be transferred to at least one other peer in the PTPN (transfer rate); and a rate at which data may be received from at least one other peer in the PTPN (receive rate); and instructing each peer in the PTPN to: transfer data to at least one other peer in the PTPN at the transfer rate; and receive data from at least one other peer in the PTPN at the receive rate.

A second aspect of the invention provides a method of optimizing real-time data exchange in a peer-to-peer network (PTPN), the method comprising: transmitting to a server: an upload limit of a peer; a download limit of the peer; and a delay between the peer and each other peer in the PTPN; receiving from the server: an instruction to transfer data to at least one other peer in the PTPN at a transfer rate; and transferring data to the at least one other peer in the PTPN at the transfer rate.

A third aspect of the invention provides a system for optimizing real-time data exchange in a peer-to-peer network (PTPN), the system comprising: at least one device capable of: receiving from each of at least a first peer and a second peer in the PTPN: an upload limit of the peer; a download limit of the peer; and a delay between each peer and each other peer in the PTPN; determining, for each of at least the first peer and the second peer: a rate at which data may be transferred to at least one other peer in the PTPN (transfer rate); and a rate at which data may be received from at least one other peer in the PTPN (receive rate); and instructing each of at least the first peer and the second peer to: transfer data to at least one other peer in the PTPN at the transfer rate; and receive data from at least one other peer in the PTPN at the receive rate.

A fourth aspect of the invention provides a computer-readable storage medium including a program product, which when executed optimizes real-time data exchange in a peer-to-peer network (PTPN), the program product comprising: program code for receiving from each of at least a first peer and a second peer in the PTPN: an upload limit of the peer; a download limit of the peer; and a delay between each peer and each other peer in the PTPN; program code for determining, for each of at least the first peer and the second peer: a rate at which data may be transferred to at least one other peer in the PTPN (transfer rate); and a rate at which data may be received from at least one other peer in the PTPN (receive rate); and program code for instructing each of at least the first peer and the second peer to: transfer data to at least one other peer in the PTPN at the transfer rate; and receive data from at least one other peer in the PTPN at the receive rate.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic view of a “server centered” network.

FIG. 2 shows a schematic view of a peer-to-peer network.

FIG. 3 shows a schematic view of a peer-to-peer network according to an embodiment of the invention.

FIGS. 4-6 show tables of information relevant to data exchange between peers in the peer-to-peer network of FIG. 3.

FIG. 7 shows a flow diagram of a method according to an embodiment of the invention.

FIG. 8 shows a block diagram of a system according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

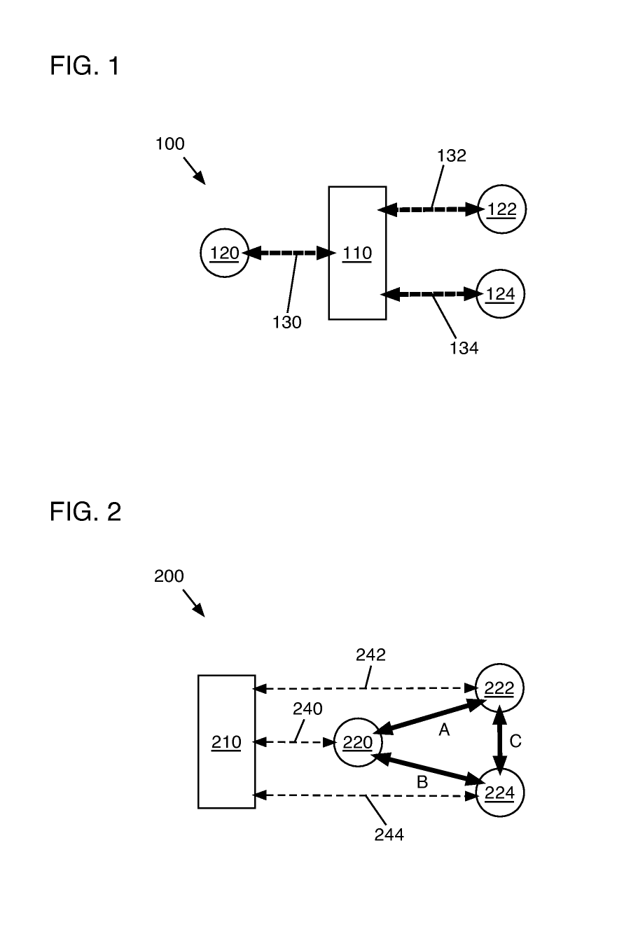

FIG. 1 shows a simple schematic view of a “server centered” network 100 including a server 110 and peers 120, 122, 124. In network 100, all data are routed through server 110, including data to be exchanged between and among peers 120, 122, 124 and administrative data (e.g., joining or leaving a video conference, etc.). Thus, data exchange 130 includes data to be exchanged between peer 120 and peers 122, 124, but also administrative data exchanged between peer 120 and server 110. Similarly, data exchange 132 includes data to be exchanged between peer 122 and peers 120, 124 as well as administrative data exchanged between peer 122 and server 110, and data exchange 134 includes data to be exchanged between peer 124 and peers 120, 122 as well as administrative data exchanged between peer 124 and server 110.

FIG. 2 shows a simple schematic view of a peer-to-peer network (PTPN), wherein data exchanges 240, 242, 244 include only administrative data exchanged between server 210 and peers 220, 222, 224, respectively. Data exchanged between and among peers 220, 222, 224 are included in peer-to-peer data exchanges A, B, C. Such an arrangement shortens the delay of data exchanged between and among peers 220, 222, 224 by excluding routing through server 210. Data exchange A may include, for example, data sent from peer 220 to peer 222. The amount, quality, compression, or other characteristics of the data, however, are based upon the capabilities and limitations of peer 220. It may be the case, for example, that the upload limit of peer 220 is very large while the download limit of peer 222 is very small. In such a case, it may be that the size or quality of the data sent from peer 220 to peer 222 exceeds the capabilities of peer 222, resulting in lost data, decreased performance of peer 222, an increase in data delay, or other undesirable outcomes. In addition, the capabilities and limitations of a peer may change over time. For example, in the case of a video conference between peers at disparate locations, the upload limit or download limit of a peer may increase or decrease as traffic on its own network changes. Thus, data exchanges of a particular size or quality that may have been acceptable at one point during the video conference may become unacceptable at another point during the same video conference. Contrarily, if a data exchange is initially made at a reduced size or quality to accommodate a limitation of a peer, this less desirable data exchange may continue throughout the video conference even though a limitation of the peer is subsequently reduced or eliminated.

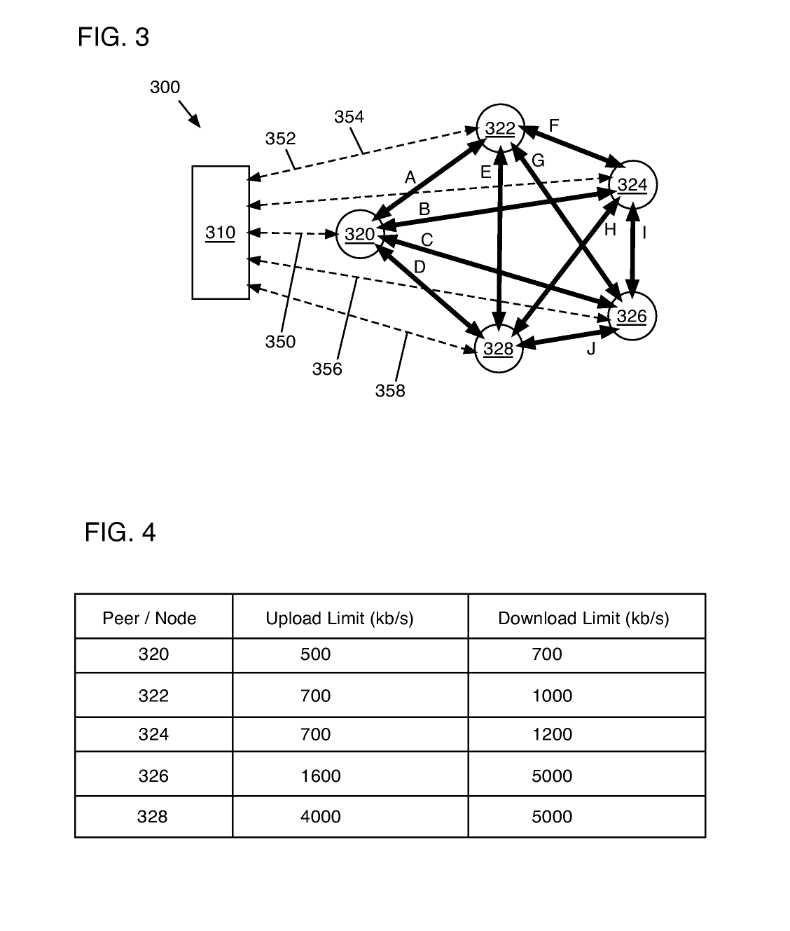

FIG. 3 shows a simple schematic view of a PTPN 300 including five peers 320, 322, 324, 326, 328, according to an embodiment of the invention. As in FIG. 2, peers 320, 322, 324, 326, 328 exchange data directly via data exchanges A through J while administrative data are exchanged with server 310 via data exchanges 350, 352, 354, 356, 358. However, in addition to the administrative data described above, data exchanges 350, 352, 354, 356, 358 further include status data sent from each peer 320, 322, 324, 326, 328 to server 310. Such status data include, for example, the peer's upload limit, download limit, and delay to each other peer. Such data are typically measured or monitored continuously by a peer and may be sent to server 310 periodically or, alternatively, when there is a change in any such data. Upon receipt of such status data from each peer 320, 322, 324, 326, 328, server 310 determines transfer rates and receive rates for each peer.

As used herein, “optimized” data exchange does not necessarily mean data exchanged at the fastest rate or even a rate at which the highest quality data may be exchanged between two peers. Rather, as used herein, “optimized” data exchange includes data exchanged between and among peers based on the particular capabilities and limitations of each peer and which provides for both efficient and reliable exchange of data between and among the peers. For example, unlike known PTPNs, where a peer typically transfers data to each other peer such that the rate or size of the transfer makes maximal use of the peer's upload limit, embodiments of the invention may determine the transfer rate of the peer to be significantly less than the peer's upload limit, if the download limits of the other peers would render them unable to efficiently receive, decode, display, or otherwise use the data.

Similarly, as used herein, “real-time” data exchange is not meant to refer to an instantaneous data exchange. Rather, “real-time” data exchange refers to both the immediate or contemporaneous transfer of data from a first peer to a second peer as the data are generated and to the immediate or contemporaneous use of such data by the second peer upon its receipt. For example, one context in which an optimized real-time data exchange according to an embodiment of the invention may be made is audio or video conferencing. In such a context, data must be transferred to and used by other peers with very little delay. Too great a delay in either transferring such data to another peer or use of such data by the other peer would lead to undue confusion among the peers. As a consequence, to avoid such confusion, many audio and video conferencing systems and programs will intentionally discard data older than a pre-determined threshold.

Accordingly, in addition to status data sent from peers 320, 322, 324, 326, 328 to server 310, data exchanges 350, 352, 354, 356, 358 further include exchange instructions from server 310 to peers 320, 322, 324, 326, 328. That is, after determining, for each peer 320, 322, 324, 326, 328, a transfer rate (i.e., a rate at which data may be transferred to another peer according to the optimized data exchange) and a receive rate (i.e., a rate at which data may be received from another peer according to the optimized data exchange), server 310 instructs each peer 320, 322, 324, 326, 328 to transfer data to another peer at the transfer rate and to receive data from another peer in the PTPN at the receive rate. In some embodiments, a transfer rate and a receive rate are determined for each pairing of peers 320, 322, 324, 326, 328. For example, still referring to FIG. 3, a transfer rate may be determined for peer 320 with respect to its transfer A of data to peer 322 that is different than the transfer rate determined for peer 320 with respect to its transfer B of data to peer 324. Exchange instructions for peer 320 to transfer data to peer 322 and peer 324 at their respective transfer rates are included in data exchange 350 from server 310 to peer 320.

Thus, server 310 is afforded a global view of the PTPN 300, including the capabilities and limitations of each peer 320, 322, 324, 326, 328. As such, server 310, while not involved in the actual exchange of data between peers 320, 322, 324, 326, 328, is able to optimize such data exchange by virtue of the global view it is afforded. Employing server 310 in making the determinations and sending the exchange instructions described above is more efficient than doing so using one or more of peers 320, 322, 324, 326, 328, which would require each peer 320, 322, 324, 326, 328 to send its upload limit, download limit, delay, etc. to each other peer 320, 322, 324, 326, 328. Aside from needlessly consuming the upload and download bandwidth sought to be most efficiently used, the peers 320, 322, 324, 326, 328 themselves would need to make the determinations, thereby monopolizing computational power that could be better employed in processing or otherwise using the data exchanged.

FIG. 4 shows a table with the upload limit (in kb/s) and download limit (in kb/s) for each peer 320, 322, 324, 326, 328 in FIG. 3. As can be seen, peer 320 has a much lower upload limit (500 kb/s) and download limit (700 kb/s) than does peer 328 (4000 kb/s and 5000 bk/s, respectively). As such, unless peer 328 knows of the lower limits of peer 320, peer 328 may attempt to transfer data to peer 320 at a rate or quality that cannot be properly received by peer 320 due to its lower download limit. Similarly, peer 328 may request data from peer 320 at a rate or quality that peer 320 cannot provide, due to its lower upload limit. One approach to solving this problem is to set the transfer and receive rates of each peer 320, 322, 324, 326, 328 to accommodate the peer(s) with the lowest upload limit and lowest download limit. This is unsatisfactory, however, as it unnecessarily and unfairly penalizes those peers with sufficient upload limits and download limits.

Rather, according to embodiments of the invention, by each peer 320, 322, 324, 326, 328 providing to server 310 (FIG. 3) its upload limit and download limit, as well as its delay to each other peer, server 310 can determine for each peer 320, 322, 324, 326, 328 a transfer rate and a receive rate with respect to each other peer, and instruct each peer 320, 322, 324, 326, 328 to exchange data with each other peer accordingly.

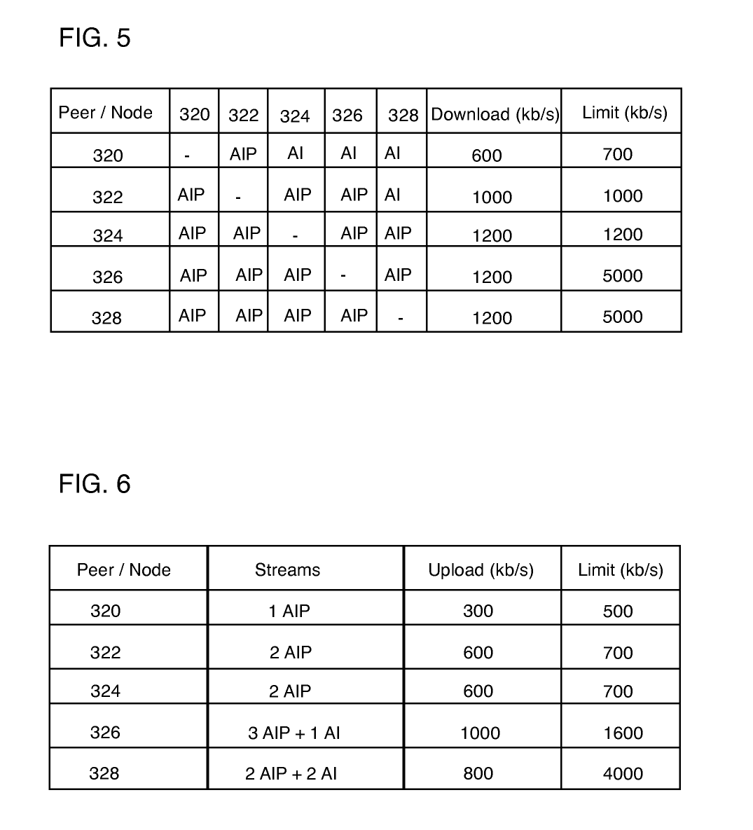

For example, FIG. 5 shows illustrative data exchanges between peers 320, 322, 324, 326, 328 in the context of a video conference. It is understood, however, that this is merely one context in which embodiments of the invention may be employed and that the exchange of any type of data may be optimized according to such embodiments of the invention. As shown in FIG. 5, “A” refers to an audio stream only, requiring approximately 50 kb/s to transfer or receive, “I” refers to video I-frames, a low-quality video stream of about 1 frame per second and requiring approximately an additional (to the A stream) 50 kb/s to transfer or receive, and “P” refers to video P-frames, a high-quality video stream requiring approximately an additional (to both the A and I streams) 200 kb/s to transfer or receive.

The preferences of individual peers 320, 322, 324, 326, 328 may be used in determining the appropriate streams each peer will transfer or receive. For example, it may be the case that one peer in the video conference is an instructor or other central peer, such that each other peer will prefer to receive a full (AIP) data stream from that peer as a priority. If, as a consequence, the download limit of a peer precludes receipt of a full data stream from other peers, a reduced data stream (e.g., AI or A) may be requested of and received from other peers in the PTPN.

Similarly, it may be the case that the instructor or other central peer has an upload limit that precludes its transfer of a full AIP data stream to each other peer requesting it. In such a case, a hierarchy or other priority system within the PTPN or with respect to the particular video conference may be used to determine the transfer rates of the instructor or central peer with respect to each other peer. In some cases, if the upload limit or download limit of one or more peers is significantly limited, the solution chosen by server 310 (FIG. 3) may be to omit data exchange between one or more pairs of peers.

Returning to FIG. 5, based on preferences of each peer 320, 322, 324, 326, 328, preferred data streams to be received by each peer from each other peer are shown. For example, peer 320 could receive a full AIP data stream (constituting 300 kb/s) from peer 322 and an AI data stream (constituting 100 kb/s) from each of peers 324, 326, and 328, resulting in total downloads of 600 kb/s. This is less than the 700 kb/s download limit for peer 320. As noted above, the determination to receive the full AIP data stream from peer 322 may be based, at least in part, on the preferences of individual peers. It may be the case, for example, that data from peer 322 are more important to peer 320 and that peer 320 would therefore prefer to receive the full AIP data stream from peer 322 and reduced AI data streams from peers 324, 326, and 328. For example, it may be the case that peer 320 and peer 322 will be interacting directly and peers 324, 326, and 328 only observing. Therefore, to provide the most realistic video conferencing experience to the most active participants, a larger portion of the upload and download limits is expended on them, with an attendant reduction in the rate or quality of data transferred to less active participants.

Still referring to FIG. 5, it can be seen that the high download limit (5000 kb/s) of peer 328 would enable peer 328 to receive full AIP data streams from each of peers 320, 322, 324, and 326, which would total only 1200 kb/s. However, as FIG. 5 shows, peers 322, 324, and 326 would also prefer to receive full AIP data streams from peer 320. For peer 320 to provide such data streams to each of peers 322, 324, 326, and 328 would require peer 320 to have an upload limit of at least 1200 kb/s. Referring to FIG. 6, it can be seen that the actual upload limit of peer 320 is 500 kb/s, significantly below the necessary 1200 kb/s and sufficient to transfer only one full AIP data stream.

Contrarily, as FIG. 5 shows, the two AIP data streams and two AI data streams requested from peer 328 total 800 kb/s, significantly below the upload limit of 4000 kb/s. Thus, as should now be clear, the transfer rate and receive rate determined for each data exchange between peers is not merely a function of the capabilities or limitations of the peers. Rather, the transfer rates and receive rates are optimized with respect to the PTPN as a whole, taking into consideration the preferences of individual peers.

It is precisely for this reason, as well as the inherent uncertainties and changeability of upload limits and download limits, that embodiments of the invention do not take advantage of small differences between the limits and the data exchanged, as is the approach of some known methods. For example, referring again to FIG. 6, the 100 kb/s difference between the preferred upload rate of peer 322 (600 kb/s) and its upload limit (700 kb/s) could theoretically be used to transfer an AI data stream at an additional 100 kb/s or two A data streams at 50 kb/s each, since a full AIP data stream was requested by each of peers 320, 324, 326, and 328 (see FIG. 5). However, the upload limit of peer 322 may well vary over time by an amount close to or greater than this 100 kb/s difference. Thus, reliance on this small difference between upload limit and transferred data may lead to an undesirable change in the rate or quality of data exchange during the video conference.

Embodiments of the invention avoid this weakness, common in known methods, by deliberately eschewing unnecessary maximization of a peer's bandwidth. Rather, the global view afforded through use of server 310 (FIG. 3) permits alternative methods of exchanging data by focusing on use of the PTPN's bandwidth as opposed to the bandwidths of individual peers. For example, as noted above and with continuing reference to FIGS. 5 and 6, four full AIP data streams are requested of peer 322, which has an upload limit permitting transfer of only two full AIP data streams. Rather than transferring to one or both of the remaining two peers a data stream of reduced quality, server 310 determines that at least one other peer (e.g., peer 328) has sufficient bandwidth to act as a “relay node” for the remaining AIP data streams requested of peer 322. Thus, for example, peer 322 may transfer AIP data streams to both peer 326 and peer 328, with peer 328 then relaying full AIP data streams to peer 320 and peer 324. The additional 600 kb/s bandwidth required to do so is added to the uploaded data of peer 328, bringing its total to 1400 kb/s, still well below its 4000 kb/s upload limit. Alternatively, both peer 326 and peer 328 may act as relay nodes, each relaying a full AIP data stream to either peer 320 or peer 324.

It is possible, of course, that in some cases, no peer has sufficient bandwidth to relay a data stream on behalf of another peer. In such cases, a determination would be made, based at least in part on the preferences of the relevant peers, whether a reduced quality data stream will be transferred, whether one or more peers will not receive a data stream from one or more other peers, or a combination thereof. Even in such a case, data exchanged in accordance with embodiments of the invention will be optimized, in that the data exchange is made based on determinations made by server 310 (FIG. 3) in view of the capabilities and limitations of both the individual peers and the PTPN as a whole.

Unlike known methods and systems, determining the transfer rate and receive rate for each peer is done individually, according to embodiments of the invention. That is, while the overall optimized data exchange is based on the capabilities and limitations of both the individual peers and the PTPN as a whole, a transfer rate and a receive rate is determined individually for each peer, based on some sorting of the peers. In some embodiments, this sorting is based on decreasing “difficulty.”

For example, a transfer rate and receive rate may be determined first for a peer having the most restricted upload limit or download limit, for a peer having a long delay to at least one other peer, or some combination thereof. Transfer rates and receive rates may then be determined for other peers, with the rates determined last for the peer having the least restricted upload limit, download limit, and/or shortest delay. This enables an efficient use of the PTPN resources by, for example, utilizing the excess bandwidth of other peers to aid in transferring the data of the most restricted peers first. Such allocation of resources may complement the deliberate avoidance of unnecessary maximization of a peer's bandwidth noted above, as the independent determination of transfer and receive rates based on decreasing difficulty will tend to “spread” bandwidth use toward peers with the greatest excess bandwidth.

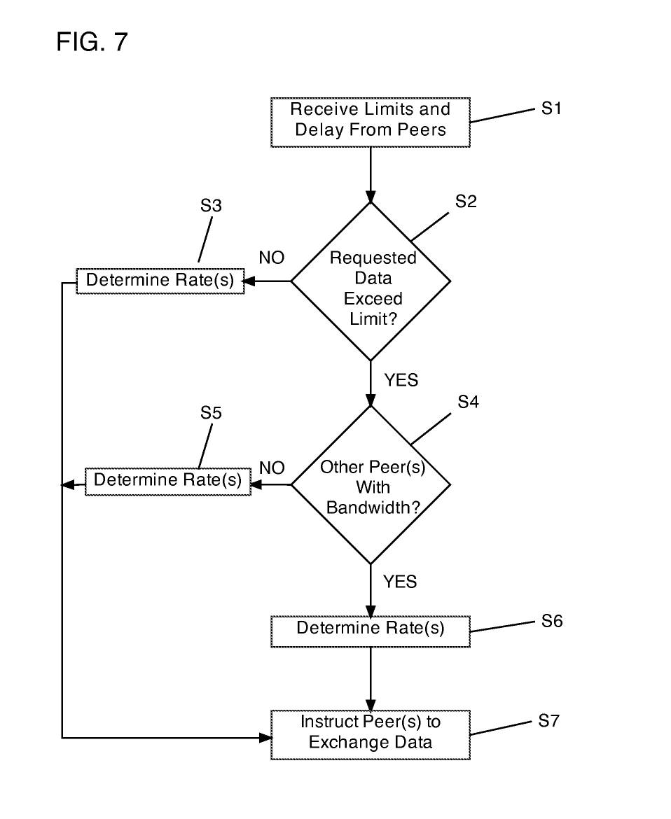

FIG. 7 shows a flow diagram of a method according to an embodiment of the invention. At 51, a server receives an upload limit, a download limit, and a delay from each peer in a PTPN. At S2, it is determined by the server whether data requested of a peer exceeds its upload limit. If not (i.e., NO at S2), transfer and receive rates are determined at S3 and each peer is instructed by the server at S7 to exchange data at the rates determined at S3.

If data requested of a peer exceeds its upload limit (i.e., YES at S2), it is determined at S4 whether one or more other peer has sufficient bandwidth to relay the requested data. If not (i.e., NO at S4), transfer and receive rates are determined at S5 and each peer is instructed by the server at S7 to exchange data at the rates determined at S5. If one or more other peer has sufficient bandwidth to relay the requested data (i.e., YES at S4), transfer and receive rates are determined at S6 and each peer is instructed by the server at S7 to exchange data at the rates determined at S6. It should be noted, of course, that the rates determined at S3, S5, and S6 will differ.

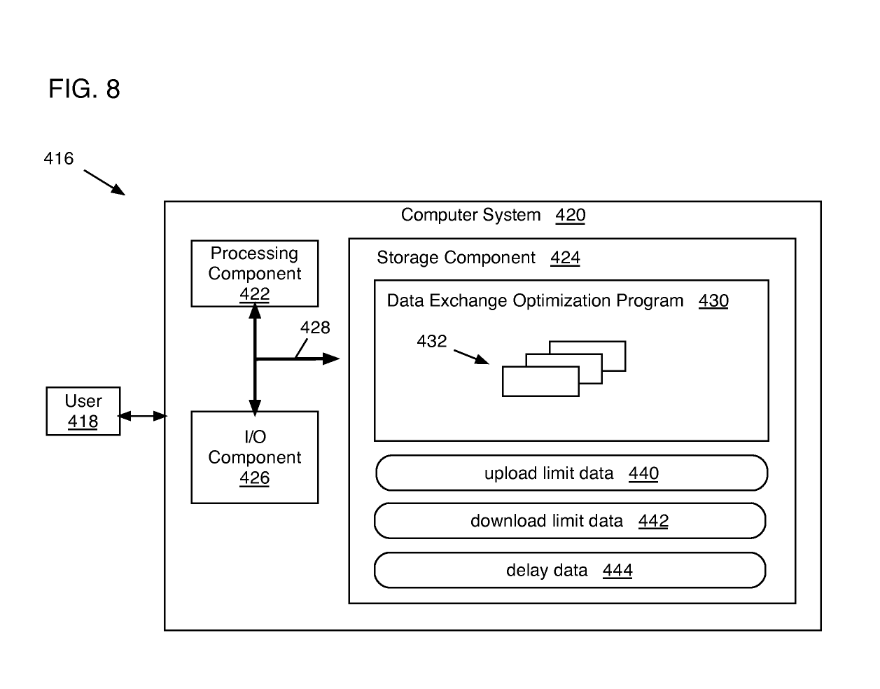

FIG. 8 shows an illustrative environment 416 for optimizing data exchange in a PTPN according to an embodiment of the invention. Environment 416 includes a computer system 420 that can perform a process described herein in order to optimize data exchange in a PTPN. In particular, computer system 420 is shown including a data exchange optimization program 430, which makes computer system 420 operable to optimize data exchange in a PTPN by performing a process described herein.

Computer system 420 is shown including a processing component 422 (e.g., one or more processors), a storage component 424 (e.g., a storage hierarchy), an input/output (I/O) component 426 (e.g., one or more I/O interfaces and/or devices), and a communications pathway 428. In general, processing component 422 executes program code, such as data exchange optimization program 430, which is at least partially fixed in storage component 424. While executing program code, processing component 422 can process data, which can result in reading and/or writing transformed data from/to storage component 424 and/or I/O component 426 for further processing. Pathway 428 provides a communications link between each of the components in computer system 420. I/O component 426 can comprise one or more human I/O devices, which enable a human user 418 to interact with computer system 420 and/or one or more communications devices to enable a system user 418 to communicate with computer system 420 using any type of communications link. To this extent, data exchange optimization program 430 can manage a set of interfaces (e.g., graphical user interface(s), application program interface, and/or the like) that enable human and/or system users 418 to interact with data exchange optimization program 430. Further, data exchange optimization program 430 can manage (e.g., store, retrieve, create, manipulate, organize, present, etc.) the data, such as upload limit data 440, download limit data 442, and delay data 444, using any solution.

In any event, computer system 420 can comprise one or more general purpose computing articles of manufacture (e.g., computing devices) capable of executing program code, such as data exchange optimization program 430, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, data exchange optimization program 430 can be embodied as any combination of system software and/or application software.

Further, data exchange optimization program 430 can be implemented using a set of modules 432. In this case, a module 432 can enable computer system 420 to perform a set of tasks used by data exchange optimization program 430, and can be separately developed and/or implemented apart from other portions of data exchange optimization program 430. As used herein, the term “component” means any configuration of hardware, with or without software, which implements the actions described in conjunction therewith using any solution, while the term “module” means program code that enables a computer system 420, such as a general purpose computing device, to implement the actions described in conjunction therewith using any solution. When fixed in a storage component 424 of a computer system 420 that includes a processing component 422, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 420.

When computer system 420 comprises multiple computing devices, each computing device can have only a portion of data exchange optimization program 430 fixed thereon (e.g., one or more modules 432). However, it is understood that computer system 420 and data exchange optimization program 430 are only representative of various possible equivalent computer systems that may perform a process described herein. To this extent, in other embodiments, the functionality provided by computer system 420 and data exchange optimization program 430 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 420 includes multiple computing devices, the computing devices can communicate over any type of communications link. Further, while performing a process described herein, computer system 420 can communicate with one or more other computer systems, such as a system user 418, using any type of communications link. In either case, the communications link can comprise any combination of various types of wired and/or wireless links; comprise any combination of one or more types of networks; and/or utilize any combination of various types of transmission techniques and protocols.

As discussed herein, data exchange optimization program 430 enables computer system 420 to optimize data exchange in a PTPN. To this extent, data exchange optimization program 430 is configured to enable computer system 420 to manage upload limit data 440, download limit data 442, and delay data 444, which computer system 420 can process to optimize data exchange in a PTPN. In an embodiment, upload limit data 440 comprises a set of data representing upload limits of peers in a PTPN, download limit data 442 comprises a set of data representing download limits of peers in a PTPN, and delay data 444 comprises a set of data representing delay limits of peers in a PTPN.

In another embodiment, the invention provides a method that performs the process steps of the invention on a subscription, advertising, and/or fee basis. That is, a service provider could offer to optimize data exchange in a PTPN, as described above. In this case, the service provider can create, maintain, support, etc., a computer infrastructure, such as computer system 420, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for optimizing data exchange in a PTPN. In this case, a computer infrastructure, such as computer system 420, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 420, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of optimizing real-time data exchange in a peer-to-peer network (PTPN), the method comprising:
receiving, from each peer in the PTPN:
an upload limit of the peer;
a download limit of the peer; and
a delay to each other peer in the PTPN;
determining, for each peer in the PTPN:
a rate at which data may be transferred to at least one other peer in the PTPN (transfer rate); and
a rate at which data may be received from at least one other peer in the PTPN (receive rate); and
instructing each peer in the PTPN to:
transfer data to at least one other peer in the PTPN at the transfer rate; and
receive data from at least one other peer in the PTPN at the receive rate.

2. The method of claim 1, wherein the determining includes:
determining whether requested data streams from other peers in the PTPN exceed the upload limit of the peer.

3. The method of claim 2, wherein, in the case that the requested data streams from other peers in the PTPN exceed the upload limit of the peer, the determining further includes:
determining whether at least one other peer in the PTPN can transfer at least a portion of the requested data streams.

4. The method of claim 3, wherein determining whether the at least one other peer in the PTPN can transfer at least a portion of the requested data streams includes:
determining whether a sum of requested data streams of the at least one other peer in the PTPN and the at least a portion of the requested data streams is greater than the upload limit of the at least one other peer in the PTPN.

5. The method of claim 3, wherein, in the case that another peer in the at least one other peer in the PTPN can transfer the at least a portion of the requested data streams, the instructing further includes:
instructing the at least one other peer in the PTPN to transfer the at least a portion of the requested data streams.

6. The method of claim 2, wherein, in the case that the requested data streams do not exceed the upload limit of the peer, the determining further includes:
determining whether the peer can transfer at least a portion of requested data streams of at least one other peer in the PTPN.

7. The method of claim 6, wherein determining whether the peer can transfer the at least a portion of the requested data streams of the at least one other peer in the PTPN includes:
determining whether a sum of the requested data streams of the peer and the at least a portion of the requested data streams of the at least one other peer in the PTPN is greater than the upload limit of the peer.

8. The method of claim 6, wherein, in the case that the peer can transfer the at least a portion of the requested data streams of the at least one other peer in the PTPN, the instructing includes:
instructing the peer to transfer the at least a portion of the requested data streams of the at least one other peer in the PTPN.

9. The method of claim 1, wherein the transfer rate is a discrete amount less than the upload limit of the peer.

10. The method of claim 9, wherein the discrete amount is less than a size of a smallest data stream requested of the peer.

11. The method of claim 1, wherein the receiving includes receiving the upload limit, the download limit, and the delay periodically.

12. The method of claim 1, wherein the receiving includes receiving the upload limit when the upload limit changes, the download limit when the download limit changes, and the delay when the delay changes.

13. The method of claim 1, wherein the data are selected from a group consisting of: audio data and video data.

14. A method of optimizing real-time data exchange in a peer-to-peer network (PTPN), the method comprising:
transmitting to a server:
an upload limit of a peer;
a download limit of the peer; and
a delay between the peer and each other peer in the PTPN;
receiving from the server:
an instruction to transfer data to at least one other peer in the PTPN at a transfer rate; and
transferring data to the at least one other peer in the PTPN at the transfer rate.

15. The method of claim 14, further comprising:
receiving data from a first peer in the PTPN.

16. The method of claim 15, wherein the transferring includes transferring the data received from the first peer in the PTPN to a second peer in the PTPN.

17. A system for optimizing real-time data exchange in a peer-to-peer network (PTPN), the system comprising:
at least one device capable of:
receiving from each of at least a first peer and a second peer in the PTPN:
an upload limit of the peer;
a download limit of the peer; and
a delay between each peer and each other peer in the PTPN;
determining, for each of at least the first peer and the second peer:
a rate at which data may be transferred to at least one other peer in the PTPN (transfer rate); and
a rate at which data may be received from at least one other peer in the PTPN (receive rate); and
instructing each of at least the first peer and the second peer to:
transfer data to at least one other peer in the PTPN at the transfer rate; and
receive data from at least one other peer in the PTPN at the receive rate.

18. The system of claim 17, wherein the at least one device is further capable of:
determining, for each of at least the first peer and the second peer, whether requested data streams from other peers in the PTPn exceed the upload limit of the peer;
determining, for each of at least the first peer and the second peer, whether at least one other peer in the PTPN can transfer at least a portion of the requested data streams; and
instructing the at least one other peer in the PTPN to transfer the at least a portion of the requested data streams.

19. A computer-readable storage medium including a program product, which when executed optimizes real-time data exchange in a peer-to-peer network (PTPN), the program product comprising:
program code for receiving from each of at least a first peer and a second peer in the PTPN:
an upload limit of the peer;
a download limit of the peer; and
a delay between each peer and each other peer in the PTPN;
program code for determining, for each of at least the first peer and the second peer:
a rate at which data may be transferred to at least one other peer in the PTPN (transfer rate); and
a rate at which data may be received from at least one other peer in the PTPN (receive rate); and
program code for instructing each of at least the first peer and the second peer to:
transfer data to at least one other peer in the PTPN at the transfer rate; and
receive data from at least one other peer in the PTPN at the receive rate.

20. The computer-readable storage medium of claim 19, wherein the program product further comprises:
program code for determining, for each of at least the first peer and the second peer, whether requested data streams from other peers in the PTPN exceed the upload limit of the peer;
program code for determining, for each of at least the first peer and the second peer, whether at least one other peer in the PTPN can transfer at least a portion of the requested data streams; and
program code for instructing the at least one other peer in the PTPN to transfer the at least a portion of the requested data streams.
